(19) United States
(12) Patent Application Publication
(10) Pub. No.: US 2008/0191867 A1
(43) Pub. Date: Aug. 14, 2008

(54) Smart Case

(76) Inventor: Maor Markovich, Kiryat Ono (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/914,137

(22) PCT Filed: May 25, 2006
(86) PCT No.: PCT/IL06/00620

§ 371 Date: Nov. 12, 2007

Related U.S. Application Data
(60) Provisional application No. 60/684,220, filed on May 25, 2005.

(51) Int. Cl. H04B 7/00; H04Q 7/00; H04B 1/00

(52) U.S. Cl. 340/539.13; 455/41.2; 340/539.11; 340/5.64; 342/357.07

(57) ABSTRACT

A case for securely carrying valuables comprises a locking mechanism that requires for unlocking a deactivation input which indicates physical proximity between a cellular component in the case and an authorized cellular device. The proximity is determined from the known location of both case and authorized cellular device. In some embodiments, the case location is derived from data acquired by a small gyroscope included in the case.

### FIELD OF THE INVENTION

The present invention relates to cases, briefcases, boxes, luggage or containers (all referred to herein as “cases”) used to carry valuables, and in particular to “smart” cases that have remote controllable safety features.

### BACKGROUND OF THE INVENTION

The use of case security devices is known in the art. More specifically, case security devices heretofore devised and utilized are known to consist basically of familiar, expected and obvious structural configurations, not withstanding the myriad of designs encompassed by the crowded prior art which have been developed for the fulfillment of countless objectives and requirements. Exemplary case security devices are disclosed in U.S. Pat. Nos. 4,719,777, 4,728,937, 4,848,111, 5,170,907, Des. 339,232, Des. 351,591 and US Patent Application No. 2005/0232747.

The use of the Global Positioning System (GPS) for tracking articles is known. For example, U.S. Pat. No. 5,223,844 discloses a security system based on GPS technology for tracking a stolen vehicle. A major disadvantage of such GPS-based tracking systems is that they require a line-of-sight between the GPS antenna and the satellite(s).

Tracking of an article using cellular technologies, alone or in combination with GPS is also known. For example, U.S. Pat. No. 5,895,436 to Savoie et al. discloses a system for tracking a vehicle using cellular telephone signals which are detected by a cellular transceiver installed in the vehicle. Such cellular telephone tracking systems suffer from lack of ground coverage and dead spots, especially when the vehicle is indoors. U.S. Pat. No. 6,774,797 discloses a system for tracking movements of an individual by means of a tracking tag which uses GPS and/or cellular telephone geolocation methods to determine its location and transmits the location information to a monitoring center.

U.S. Pat. No. 6,975,222 to Krishan et al discloses an asset securing and tracking system that operates in conjunction with a wireless communication network for tracking a portable asset. The system includes a tracking device adapted to be attached to the portable asset and communicate with the wireless communication network. The tracking device determines the location of the asset using signals from GPS satellites and the terrestrial wireless communication network. A monitoring station receives and processes a location signal regarding the geographic location of the portable asset from the tracking device via the wireless communication network.

Smart cargo systems, in which the locking/unlocking of the cargo is controlled by a security apparatus that includes a microcontroller in communication with a remote control center are known. U.S. Pat. No. 5,648,763 discloses a security system for controlling access to cargo containers having a receiver for receiving LORAN-C or GPS signals and using them to produce a position signal corresponding to the current geographic position of the container. This position signal is compared with a preset signal representing a predetermined geographic position and, when the two correspond, an enabling signal permits the security system to gain access to the container. Again, the use of GPS introduces line-of-sight limitations, LORAN-C is limited to maritime applications, and only the one location of the container is of interest or consequence.

U.S. Pat. No. 7,038,585 to Hall et al. discloses a security apparatus which provides for a cargo asset monitoring and tracking capability. The security apparatus may contain a physical locking function which provides a physical deterrent to an attached item such as a shipping drum. A microcontroller is provided within the security apparatus which monitors and coordinates locking/unlocking functions of the security apparatus, monitors an associated sensor to detect alarm conditions, monitors information from an RF transceiver with respect to proximity alerts and monitors information from one or more sensors incorporated within the security apparatus, the sensors providing information which may indicate tampering or damage to the cargo. The security apparatus is able to provide an audible alarm as well as communicate with a remote monitoring station upon detection of an alarm condition. A tracking system and process of monitoring and controlling the security apparatus from a remote location are also disclosed.

US Patent Application No. 2005/0232747 by Brackmann et al discloses a smart cargo container system comprising auditable, secure, sealable, stackable, trackable and pollable, universal, “pallet boxes”. Sophisticated battery-powered electronic locks, sensors and alarms are provided, as well as an RF communications and GPS locator module that radios to a base station the time, location and status of the inventive smart cargo container, and any anomalous events as they occur, including unauthorized attempts to open or break into the container, or potential damage events. In addition, both the locks and communication modules are programmable, and provide extensive, and selectably pollable and downloadable event, access and transport history and audit trails. The communication system permits remote tracking and real time status check via the Internet, LAN or WAN wireless networks.

The use of small gyroscopes (“gyros”) for navigation purposes and for providing a record of a navigated route (or location) is known. A very small Inertial Navigation System (INS) with GPS (MIDG II INS/GPS) is available from Microbotics Inc., 28 Research Drive, Suite G, Hampton, Va. 23666-1364, USA. Small tri-axial gyros are available from Omni Instruments, East Kingsway Business CentreMid Craigie Trading Estate, Mid Craigie Rd, Dundee, DD4 7RH, Scotland, UK. However, the use of gyroscopes as tracking/location of cases is not known.

In view of the obvious limitations of existing tracking systems and smart cargo systems and the increased security required by cases used to transport valuables such as diamonds, jewelry, cash, etc, it would be advantageous to have a “smart” secure case that does not suffer from the disadvantages of known case security devices.

### SUMMARY OF THE INVENTION

The present invention relates to case security devices and more particularly pertains to a “smart” case with a remotely controlled locking mechanism for allowing the case to be opened in a specific location. The opening location may be predefined and/or programmed into the case, or determined remotely. The case includes a safety mechanism that can detect a hostile event through a set of predefined rules. Exemplary detectable hostile events include attempts to open by force or unauthorized manner, unreasonable shaking, detours from a predefined route or destination and repeated inputs of a wrong unlocking code to open the case. The case can transmit its whereabouts at all times, allowing a remote control center (or simply “remote controller”) to manage it. Also, the case is able to detect a theft situation and react to it by issuing an alarm and by notifying the remote controller. The case includes a location finder based on GPS (global positioning system), cellular LBS (location based service), gyroscope or a combination thereof, and a communication mechanism to communicate with the remote controller. In the present invention, the term “GPS” also includes signals from alternative satellite positioning systems (e.g., GNSS, GLONASS, Galileo, MSAS, EGNOS, Look-Down, etc.), and positioning sensors. The case is programmable and remotely controllable by the remote controller. Particularly inventive features of the case include the use of a cellular function as a key security feature, and the use of a gyroscope as a back-up tracking device or as an autonomous navigation device.

According to the present invention there is provided a case for securely carrying valuables that includes a locking mechanism for locking and unlocking the case and a smart controller with a cellular component that provides a security input for deactivating the locking mechanism, wherein the security input requires physical proximity of the case cellular component to an authorized cellular device, the cellular component further providing cellular tracking and communication functions.

According to the present invention there is provided a case for securely carrying valuables including an envelope containing the valuables therewithin, a locking mechanism for preventing access to the valuables within the envelope except when a required plurality of security inputs is provided, a cellular component residing within the envelope and which serves as one of the plurality of security inputs and a smart controller for controlling actions involving the locking mechanism and the cellular component.

According to the present invention there is provided a method for providing a secure case for carrying valuables, the case having an envelope for containing the valuable therewithin, the method including the steps of providing a locking mechanism for locking and unlocking the case and using a cellular security input to deactivate the locking mechanism, thereby opening the case, wherein the security input requires physical proximity of a cellular component included in the case to an authorized cellular device.

In some embodiments, the case location input is provided by a location providing system selected from the group of a GPS, a cellular communication system, a gyroscope included in the case and a combination thereof.

In some embodiments, the case is autonomous. The “autonomous” feature refers to a capability of the smart controller to switch between tracking modes (GPS/cellular/gyro), to navigate and to compare stored security inputs with externally supplied inputs in order to allow unlocking.

### BRIEF DESCRIPTION OF THE DRAWINGS

For a better understanding of the present invention and to show more clearly how it could be applied, reference will now be made, by way of example only, to the accompanying drawings in which:

FIG. 1 shows schematically the smart case of the present invention in: a) front and back isomeric views; b) a block diagram with the key mechanisms;

FIG. 2 shows details of various key mechanisms of the smart case;

FIG. 3 shows elements of a communication and control system using to track and control a smart case.

### DETAILED DESCRIPTION OF THE INVENTION

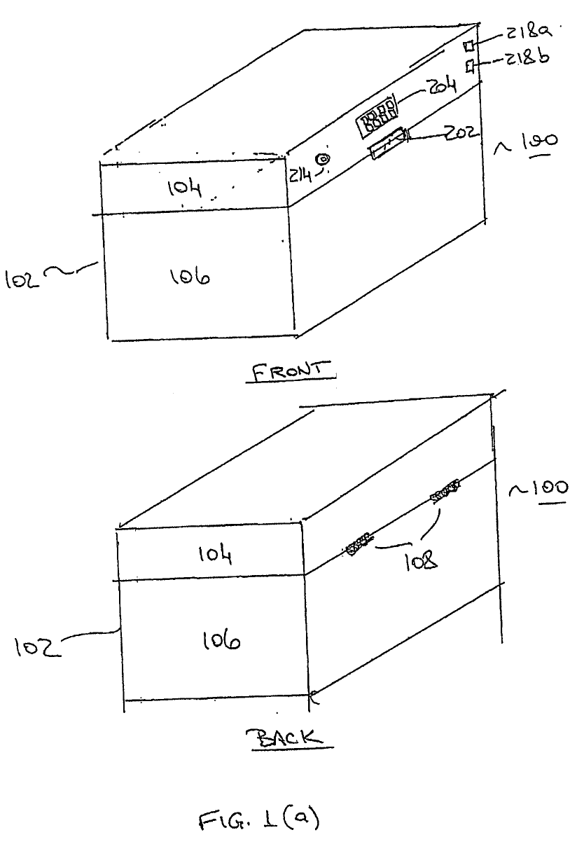

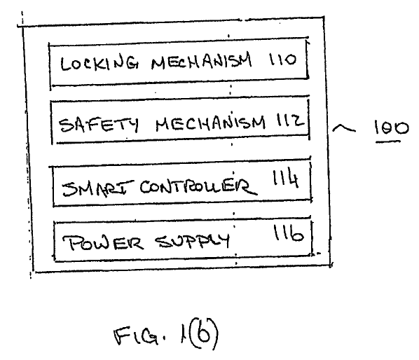

FIG. 1 shows schematically a smart case 100 of the present invention in: a) front and back isomeric views and b) a block diagram with the key mechanisms. Case 100 includes an external envelope 102 (which can be made of any normal case material such as hard plastic or metal), exemplarily divided into two sections 104 and 106. In some embodiments, the two sections are connected on one side by hinges 108 that allow a relative rotation for opening and closing the case (as in normal hard sided briefcases). In other embodiments, the two sections may be joined and designed to open and close in any known manner. More than two sections and other shapes, sizes and materials may be used to fabricate the case, for example as described in US Patent Application No. 2005/0232747 by Brackmann et al. Case 100 includes in general a locking mechanism 110 (e.g., as in a briefcase on a side opposite to the hinges), a safety mechanism 112, a smart controller and processing module (also referred to as “smart controller” or “brain”) 114 and a power supply mechanism 116. Module 114 has control, data processing, data storage, tracking (location), communication and, in some embodiments, autonomous decision making capabilities. In essence, module 114 has capabilities of modern portable electronic devices, in particular portable computers combined with GPS/cellular tracking and communication functions. In some embodiments, module 114 is programmed to enable the case to perform autonomous decisions, such as a decision to switch between tracking modes, to allow unlocking upon a match of stored conditions with input conditions and to navigate to a predetermined destination

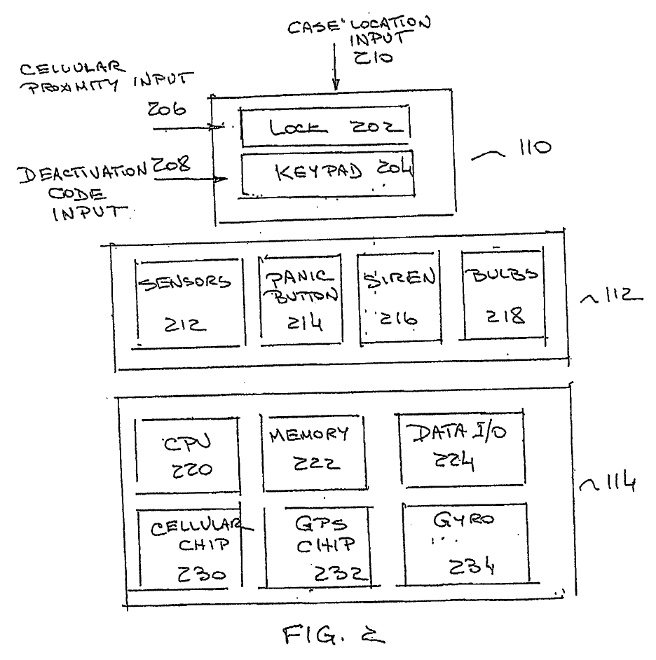

FIG. 2 shows details of some of the mechanisms of FIG. 1. Locking mechanism 110 preferably includes an electromechanical (solenoid based) lock 202. The lock can be activated (locked) by input of an activation code through a keypad 204, either directly or remotely. The deactivation (unlocking) inventively requires input of a cellular “proximity” input 206, which serves as a key security feature of the smart case, in combination with an input of a correct deactivation code 208 through keypad 204. In some embodiments, the unlocking requires an additional, third security input 210 in the form of a correct case location obtained via the cellular/GPS/gyroscope components. The various security inputs are processed by the smart controller. Cases with other types of locks that can be opened or closed by external inputs that include a code, a cellular input and/or a location input should also be considered within the scope of the present invention.

Safety mechanism 112 may include various sensors 212, for example electromagnetic, optical or vibration sensors that can sense hostile events and output respective indications. As mentioned, hostile events also cover attempts to input a wrong deactivation code more than a predetermined number of times; deviation of the case from a predetermined route; attempts to open the case in un-predetermined or pre-programmed locations; and pressing of a panic button (see below). The indications can be compared with appropriate “rules” preprogrammed into the smart controller or provided by the remote controller. Sensors that can provide hostile event indications are known in the art and described for example in US Patent Application No. 2005/0232747 by Brackmann et al. The sensors are coupled to module 114, which can relay their indications to the remote control center through its communication function. Safety mechanism 112 may further include a panic button 214 for allowing the case carrier or authorized person to issue a silent alarm to the remote controller, and a siren 216 that can be activated upon sensing of a hostile event. The safety mechanism may further include various indicators, e.g. a locking bulb 218a and an unlocking bulb 218b that indicate when the case is respectively “armed” or “unarmed”.

Module 114 typically includes a programmable microprocessor or central processing unit (CPU) 220, a memory section 222 and data input/output capabilities 224. The module further includes a cellular chip 230 which can automatically track and provide the case location, and which is also used for cellular communications. Any cellular tracking and transmission technology may be used in the smart case of the present invention. Exemplarily, the tracking and communication may follow those described in U.S. Pat. No. 6,774,797. In some embodiments, module 114 further includes a GPS component (chip) 232 in addition to the cellular chip. In other embodiments, module 114 further includes a small gyroscope (for example a micro-electro-mechanical system (MEMS)-type gyroscope) 236 in addition to the cellular chip or in addition to both cellular and GPS chips. It should be clear that although the cellular chip is an essential component that is included in each module 114, the GPS and gyroscopes components are not. When present, the gyroscope is used either as a back-up tracking and location-calculation element in cases when the cellular/GPS tracking fails, e.g. when the case is out of range for both GPS and cellular tracking, or as a main navigation component, working in cooperation with other module 114 component to direct the case from a source to a destination (source and destination referring to both location and a sending/receiving person). Cellular chips, GPS chips and small gyroscopes are well known in the art. Exemplary small gyroscopes or combination gyroscope/GPS components that may be used in the smart case of the present invention are mentioned in the Background above.

Module 114 further includes components that facilitate communication with the remote controller through any known transmission technology used for example in communications between computers, PDAs and other modern electronic devices. These include wireless (GSM/CDMA), network-mediated (X1 or GPRS or EVDO) and short range transmission (Bluetooth or infrared) technologies. Module 114 is operative to perform various functions such as receiving and identifying codes input to the locking mechanisms, data input from the remote controller and from cellular devices, sensor indications and location data input from GPS or other tracking/locating systems. Module 114 is further operative to use the processed data, either alone or through interaction with the remote controller to provide commands to the locking mechanism to open the lock and to decide on sounding an alarm in response to sensor indications of a hostile event.

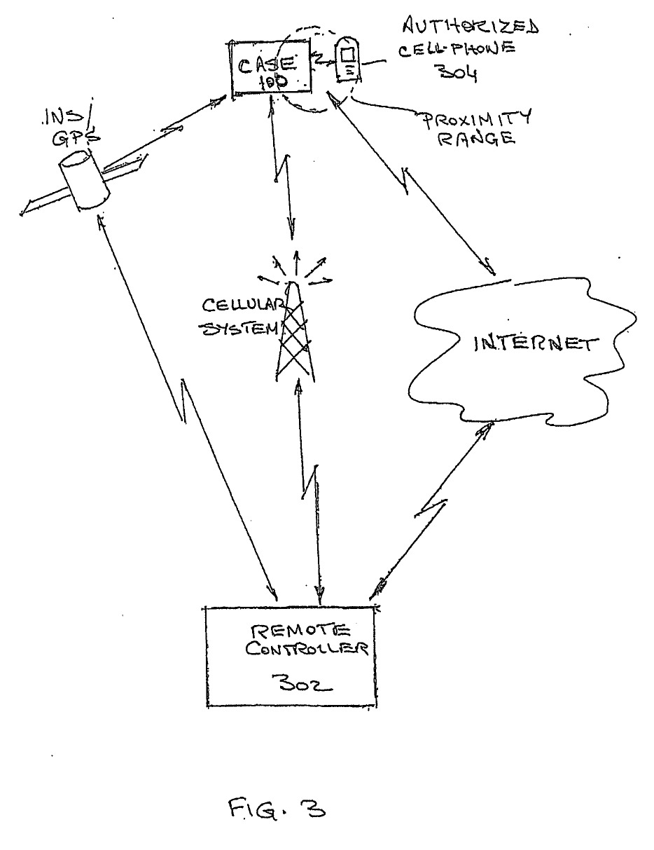

In use, the case (with valuables inside) may be carried physically by a human carrier or be shipped from a source to a predetermined destination. Exemplarily, the case is tracked by a remote controller 302 (FIG. 3) at all times through its cellular, cellular+GPS, cellular+gyroscope or cellular+GPS+gyroscope functions. Any cellular/GPS tracking system, for example as described in U.S. Pat. No. 5,895,436 or 6,975,222, may be used for the purposes of the present invention. The case is locked at the source and can be opened at the destination by an authorized person 304 only through the fulfillment of at least two conditions (inputs): availability of a correct opening code, and the case being located close (in proximity) to an authorized cellular device uniquely identifiable with the authorized person. To further enhance the security aspect, a third input of the case being located in a defined location may be added to the first two inputs as a requirement for unlocking.

To remove any doubt, the acceptance or rejection of external inputs in the decision to unlock the case may be made autonomously by the case or through remote instructions from the remote controller to the case. In the first situation, the case is referred to as “autonomous”. In the second, the case is referred to as “remotely controlled”

The cellular “proximity” feature works as follows: the cellular function of the case can communicate with the authorized cell-phone. Both the case and the authorized cell-phone are tracked and their locations known. In remotely controlled unlocking, the remote controller instructs the smart controller of the case to allow unlocking only when the case is physically close to the authorized cell-phone. In autonomous unlocking, the evaluation of the physical proximity may be made either by the case receiving directly cellular location inputs or through direct communication between the cellular functions. The physical cellular proximity is a necessary condition for any case unlocking action of the present invention. To remove any doubt, “proximity” as used herein implies a distance or “range” between the cellular component of the case and the authorized cellular device which allows physical contact between the authorized person and the case. Clearly, cellular based location has known resolution, and the distance between two proximal devices can be established only within the limits of this resolution. One can see the location resolution of a given cellular technology as the upper limit of the proximity range

When the unlocking inputs are provided to the smart control mechanism by remote controller 302, the remote controller may:

a) establish the case location, recognize an opening request and enable the opening of the case if its location is within permitted spatial and temporal boundaries.

b) alert when the case is diverted from a predefined route or location.

c) control each case in terms of locking, unlocking and setting off an alarm.

d) provide a user with a “case situation” that includes: opening requests, location outside a permitted area, lack of communication and battery depletion.

e) allows a user to update times and locations in which the case may be opened.

f) provide a fast connection to the closest law enforcement office, supplying a web page that will show the whereabouts of the case being tracked.

g) supply a user with the ability to track the exact location and previous route of his/her cases at any given time.

h) maintain a route history of each case.

Electrical power to various case mechanisms and components is supplied (as for example to a mobile electronic device) by power supply mechanism 116. Such mechanisms are well known in the art. Mechanism 116 may include an independent power source such as a battery 270, either non-rechargeable or chargeable. If chargeable, an adequate charging port 272 is supplied to the case to allow operative coupling of the power supply to an external charging source (not shown). Any type of power source used for example in mobile electronics and well known in the art may be used to power the smart case of the present invention. In some embodiments, parts of mechanism 116 (e.g. the battery) may be included in module 114, making the smart controller “self-powered”.

All acronyms mentioned herein and not specifically spelled out are well known in the art and can be found in at least one of the references cited. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A case for securely carrying valuables comprising:
a. a locking mechanism for locking and unlocking the case; and
b. a smart controller with a cellular component that provides a security input for deactivating the locking mechanism, wherein the security input requires physical proximity of the case cellular component to an authorized cellular device, the cellular component further providing cellular tracking and communication functions.

2. The case of claim 1, wherein the cellular component includes a cellular chip.

3. The case of claim 1, further including a safety mechanism coupled to the smart controller and operative to sense hostile events and produce respective indications and alarms.

4. The case of claim 2, wherein the smart controller further includes a global positioning system (GPS) tracking component.

5. The case of claim 2, further including a gyroscope component that provides autonomous navigation capabilities to the case.

6. The case of claim 4, wherein the smart controller further includes a gyroscope component that complements the GPS and cellular communication components in case tracking activities.

7. The case of claim 2, wherein the smart controller is autonomous to perform an action selected from the group consisting of navigation, tracking mode switching and locking mechanism deactivation

8. The case of claim 2, wherein the smart controller is operatively coupled to a remote controller that provides instructions for the locking mechanism deactivating action.

9. A case for securely carrying valuables comprising
a. an envelope containing the valuables therewithin;
b. a locking mechanism for preventing access to the valuables within the envelope except when a required plurality of security inputs is provided;
c. a cellular component residing within the envelope and which serves as one of the plurality of security inputs; and
d. a smart controller for controlling actions involving the locking mechanism and the cellular component.

10. The case of claim 9, wherein the plurality of security inputs further includes a deactivation code.

11. The case of claim 10, wherein the plurality of security inputs further includes a case location input.

12. The case of claim 11, wherein the case further comprises a global positioning system (GPS) component and a gyroscope component and wherein the location input includes an input selected from the group of a GPS input, a cellular input, a gyroscope input and a combination thereof.

13. The case of claim 9, wherein the cellular security input provided by the cellular component includes an input indicating physical proximity between the cellular component and a cellular device carried by a person authorized to unlock the case.

14. The case of claim 9, wherein the smart controller is autonomous in its controlling actions

15. A method for providing a secure case for carrying valuables, the case having an envelope for containing the valuable there within, the method comprising the steps of:
a. providing a locking mechanism for locking and unlocking the case; and
b. using a cellular security input to deactivate the locking mechanism, thereby opening the case, wherein the security input requires physical proximity of a cellular component included in the case to an authorized cellular device.

16. The method of claim 15, wherein the step of using a cellular security input to deactivate the locking mechanism includes using the cellular security input in combination with a deactivation code.

17. The method of claim 16, wherein the step of using the cellular safety component in combination with a deactivation code includes further using an additional security input in the form of a case location.

18. The method of claim 17, wherein the case location input is provided by a location providing system selected from the group of a global positioning system (GPS), a cellular communication system, a gyroscope included in the case and a combination thereof.

19. The method of claim 15, wherein the step of using cellular security input to deactivate the locking mechanism is performed autonomously by a smart controller of the case.

20. The method of claim 15, further including the step of providing a gyroscope included in the case and used for autonomous case navigation
